(19) United States
(12) Patent Application Publication
(10) Pub. No.: US 2006/0086076 A1
(43) Pub. Date: Apr. 27, 2006

(54) Self-Propelled Harvesting Machine

(75) Inventors: Bernard Krone, Spelle (DE); Josef Horstmann, Ibbenburen (DE)

Correspondence Address: GUDRUN E. HUCKETT DRAUDT, LONSSTR. 53, WUPPERTAL, 42289, DE

(73) Assignee: MASCHINENFABRIK BERNARD KRONE GMBH, Spelle (DE)

(21) Appl. No.: 11/162,806

(22) Filed: Sep. 23, 2005

(30) Foreign Application Priority Data
Sep. 24, 2004 (DE) 10 2004 046 467.7

(51) Int. Cl. A01D 75/30

(52) U.S. Cl. 56/6

(57) ABSTRACT

A self-propelled harvesting machine has a chassis supported by drive wheels on the ground and a first drive for propelling the harvesting machine. At least one second drive for driving at least one working or harvesting device is provided. A drive unit that provides a variable total drive power for the first and second drives is provided. The drive unit has at least two drive motors. At least one common gear unit is associated with the at least two motors for transmitting a rotational movement. A control and regulating device controls a course of action for connecting a second one of the at least two motors to the common gear unit.

### BACKGROUND OF THE INVENTION

The invention relates to a self-propelled harvesting machine, in particular, a field chopper for taking up and chopping a crop such as corn, green feed or the like, comprising a chassis whose machine frame is supported by drive wheels on the ground, further comprising a propelling drive and at least one drive for at least one driven working and/or harvesting device such as a crop pick-up and feed device, a working device for chopping, a transfer device for transferring the crop, wherein a variable total drive power for all drives is provided by a single drive unit.

Because of increasingly larger contiguous cultivated fields that are to be worked or harvested in increasingly shorter periods of time with as little personnel as possible, the trend toward powerful self-propelled agricultural harvesting machines is unbroken.

All of these machines have a few special common features. As a result of the high complexity of such machines, the purchase price is high. In order for such a high purchase price to amortize, the efficiency of such devices must be increased even more. For example, the working width of the harvesting attachments is increased and the throughput of threshing and chopping devices is increased. Moreover, for traveling on roads such machines should have a permissible driving speed as high as possible in order to enable a quick relocation. However, all of these developments face limits that can be set, inter alia, by technical feasibility or by legal regulations; in this connection, the goal is to fulfill these by intelligent technical solutions or by technical expenditure at costs as low as possible or to eliminate these limits.

The German patent document DE 200 07 994 U1 describes a self-propelled harvesting machine with an attachment of a great working width. This disclosure concerns the problem of road safety when driving on roads at high speed. In this connection, all components of the harvesting machine have an arrangement relative to one another such that the center of gravity of the operative machine as a whole including its attachment is positioned in the travel direction at a certain spacing behind the front axle and at a certain level above the ground level. In this way it is to be ensured that even at high travel speeds with mounted attachment the machine remains safely controllable and that, in particular, the operative safety is ensured in all operating states. Even for braking actions, the steerability of the operative machine is maintained up to the highest travel speeds of approximately 40 kilometers per hour even on uneven ground and for a high total weight of the machine.

For example, in order to be able to fully take advantage of the total efficiency of a high-end chopping device of the prior art, at present motor power of more than •kW is installed in such machines. Such large size powerful motors however are not mass-produced and therefore increase the manufacturing costs of the machine as a whole significantly. Moreover, increasing motor size also is increasingly disadvantageous in regard to environmental considerations and the economic operation of the working machine. In particular, in the case of machines that are operated in different applications with different degree of utilization of its capacity, for example, in the case of field choppers, these disadvantages have a particularly strong effect. For example, in the case of a corn chopper the full capacity of the field chopper is taken advantage of, but in the case of harvesting grass it is not possible to fully utilize the machine capacity because of the significantly reduced amount of crop and of the unused and switched off devices such as the grain processor. However, since for the proper function of the field chopper a constant minimum engine speed is required, the field chopper is operated in such applications in an uneconomical range at much too high fuel consumption. This is similar in the case of traveling on roads. In this operating state, a significantly smaller drive motor that provides a minimal fuel consumption and more beneficial exhaust gas and noise emission levels would be fully sufficient.

German patent DE 34 39 710 C2 discloses an agricultural tractor in which a drive motor acts through a gear assembly and/or a rear-mounted gear for driving a connectable power take-off shaft. A second attachable motor can be connected by a front-mounted gear to the gear assembly so that the output of propelling drive and/or of the first power take-off shaft and/or of a second power take-off shaft can be increased. The front-mounted gear distributes the power of the second motor as needed through the gear assembly onto the propelling gear with or without the first and second power take-off shafts or only to the second power take-off shaft; by means of the rear-mounted gear the first power take-off shaft and the second power take-off shaft can be driven commonly by the second motor. A disadvantage is that the number of gear systems requires an enormous constructive expenditure and, moreover, a sizable mounting space must be made available that, in the case of the already large harvesting machines of the type in question, would lead to a significant increase of total size of such a machine; however, there are also limits to that as a result of legal regulations. The clutches for connecting and disconnecting the individual gear systems must be manually operated by the operator; this requires a intensive concentration on the part of the operator and leads to a correspondingly high risk in regard to operating errors. Moreover, the individual gear systems must be positioned at different locations which requires a significant number of connecting elements for transmitting the drive energy. This can also be disadvantageous in regard to the center of gravity of the vehicle.

U.S. Pat. Nos. 4,131,170 and 4,161,991 discloses an agricultural tractor that has at least two drive motors. These drive motors can be turned on independently from one another and are arranged in the longitudinal direction of the vehicle behind one another. The two drive motors have a common toothed gear transmission with spur toothing that can be coupled to the output shafts of both motors. This must be done by the operator of the agricultural tractor so that again a labor-intensive and concentration-intensive operating work is to be performed.

### SUMMARY OF THE INVENTION

It is an object of the present invention to provide an especially efficient self-propelled harvesting machine of the aforementioned kind in which, under any operating condition, an especially economic and environmentally friendly drive device can be operated. Moreover, with regard to its drive device, manufacturing costs that are as cost-efficient as possible are to be ensured. Moreover, the self-propelled harvesting machine should be configured to be operator-friendly as much as possible.

In accordance with the present invention, this is achieved in that the self-propelled harvesting machine is characterized in that the drive unit has at least two drive motors of which at least one is associated with a common gear unit that transmits a rotational movement and in that a control and regulating device is provided for controlling the course of connecting the at least one additional drive motor.

The self-propelled agricultural working machine according to the invention is characterized primarily by a drive device that provides for all types of operation and application conditions the required drive power in a way that is beneficial with regard to energy consumption and that is environmentally friendly. This is realized by the at least two drive motors of the drive unit wherein for the two-motor or multi-motor drive unit of the harvesting machine, for example, two identical diesel engines can be used. It is not necessary that the engines are identical but this simplifies significantly the construction, design, and manufacture as well as future maintenance and replacement part storage; accordingly, the suggested embodiment reduces costs in general. Also, primarily for cost reasons, diesel engines as drive motors are beneficial; however, all other types and combinations of drive motors are conceivable. The motors of the power range that is to be employed for a drive unit with two motors are motors that are mass-produced and together are less costly than a large high-performance motor that is manufactured only in small numbers. In addition to the advantages in regard to reduced purchase costs of the harvesting machine according to the invention, there are also significant operating cost benefits that are primarily obtained by matching the power output to the application spectrum, respectively, by selecting the number of the motors for the driving action, this leading to optimized fuel consumption. In addition to the reduced fuel consumption, optimized exhaust gas emissions can also be obtained by avoiding that the drive motors operate under partial load. When traveling on roads, the noise emission can be significantly reduced.

In a constructively compact configuration, the two or more motors have a common gear unit correlated therewith as well as a control and regulating device that controls the type of connecting of the motors. In this way, it is possible to operate the harvesting machine according to the invention that is provided with a multi-motor drive unit, depending on the current operating conditions, in a preselectable way with regard to all functions only with the main motor, if desired. Such operating conditions for the advantageous use of only one motor are, for example, traveling on roads or, in the case of a powerful field chopper, its use for harvesting grass or similar applications that are to be performed at a reduced machine output. When the application conditions or the individual application situation changes such that the main motor that provides the drive power alone is the efficiency-limiting component of the working machine, the operator can select the multi-motor drive action in order to demand the entire power output of the drive unit and to thus utilize the full capacity of the machine. In this connection, the control and regulating device is provided in the harvesting machine according to the invention with which the course of connecting of the at least one additional drive motor is controlled. This is realized in that the operator triggers a signal for the desired multi-motor drive operation. A basic condition that is not mandatory but in a preferred embodiment of the invention a measure provided for safety considerations, is that, in order to be able to start the process of connecting the motors, the main motor has been started first and is idling and at least one additional motor to be coupled to the main motor has also been started and is idling. The main motor is started as is known in the art preferably by an electric starter. The additional motor or several additional motors can be started in the same way or by their own starter, respectively, or by the power of the main motor. In different embodiments it is, for example, conceivable that the main motor, advantageously at low engine speed, entrains the additional motor by a downstream coupling or that, by means of a rotating mass that is driven by the main motor, kinetic energy is stored and is used, independent of the current engine speed of the main motor, for starting the additional engine.

A rigid coupling of the drive motors causes a very precise finely adjusted synchronization of the motors because the motors otherwise would work against one another causing very great undesirable forces to act on the drive elements between the motors and leading quickly to damage. Moreover, for insufficient synchronization of the motors as a result of energy dissipation within the drive a very low efficiency would be achieved.

In particular the moment of coupling the motors, preferably by a friction clutch, is a critical moment that must be controlled as precisely as possible.

For this reason, according to the invention the motors are run up by the control and regulating device of the working machine after fulfilling the start conditions for the multi-motor drive action to the upper idling speed because in this range there is no large engine speed fluctuation anyway and the motors, moreover, in this engine speed range only have a relatively minimal torque so that the load on the drive elements at the moment of coupling is minimized.

When the motors to be coupled have been brought within the range of the upper idling speed to a predetermined precise synchronization as much as possible by the control and regulating device, coupling of the motors by connecting the at least one additional drive motor by means of a clutch is realized.

Now the entire power output of the drive motors is available for the main power train as well as for the auxiliary power take-off devices of the gear unit of the drive unit.

In the case of disruptions in the sensor-monitored synchronization of the motors or in the case of other disruptions that represent a safety risk or can cause damage, safety switches of the control and regulating device ensure an immediate controlled shut-down at least of the at least one additional drive motor.

The self-propelled agricultural working machine according to the invention has a compact drive unit that is comprised preferably mainly of a gear unit transmitting rotational movement and designed in the form of a spur gear unit and two diesel engines directly flanged thereto, wherein this compact drive module can be completely preassembled and inserted as such into the working machine. As a connecting and stabilizing element an auxiliary frame is provided that rigidly connects the two parallel arranged motors at their end that is located opposite the take-off side and thus also opposite the gear unit. Moreover, the auxiliary frame is a connecting element between the drive unit and the chassis of the working machine. The corresponding connecting function at the opposite side of the drive unit is taken on by a support of the gear unit. Elastic fastening elements positionally fix and secure the drive unit.

As a whole, the drive unit according to the invention, in a preferred embodiment, provides a transverse connection between the lateral frame supports extending in the longitudinal direction of the harvesting machine (vehicle).

Advantageously, one of the motors of the drive unit is embodied as the main motor by which the main power train of the working machine can be driven directly, engaged and disengaged by a clutch, without force diversion through the gear unit. Moreover, by means of auxiliary power take-off devices this main motor also operates devices that are required for operation, for example, the alternator and the cooling fan; this has the advantage that their drive action is constructively simple and must not be present several times. All additional drives of the working machine are taken off the gear unit of the drive unit and can also be driven by the main motor. In an especially advantageous configuration of the working machine according to the invention the drives that are driven by the gear unit of the drive unit are hydraulic drives wherein the hydraulic pumps of the drives are flanged directly to the gear unit of the drive unit.

### BRIEF DESCRIPTION OF THE DRAWING

FIG. 1 is a side view of a field chopper as an example of a self-propelled agricultural working machine, showing in a view from the left the partially exposed drive unit.

FIG. 2 is a detail illustration of the exposed drive unit with auxiliary drives according to FIG. 1.

FIG. 3 is a view of the exposed drive unit of the field chopper embodiment according to the invention a view from the rear.

FIG. 4 is a detail view of the drive unit from the right side corresponding to the illustration of FIG. 2.

FIG. 5 is a perspective view of the partially schematically illustrated drive unit of the field chopper according to FIG. 1.

### DESCRIPTION OF THE PREFERRED EMBODIMENTS

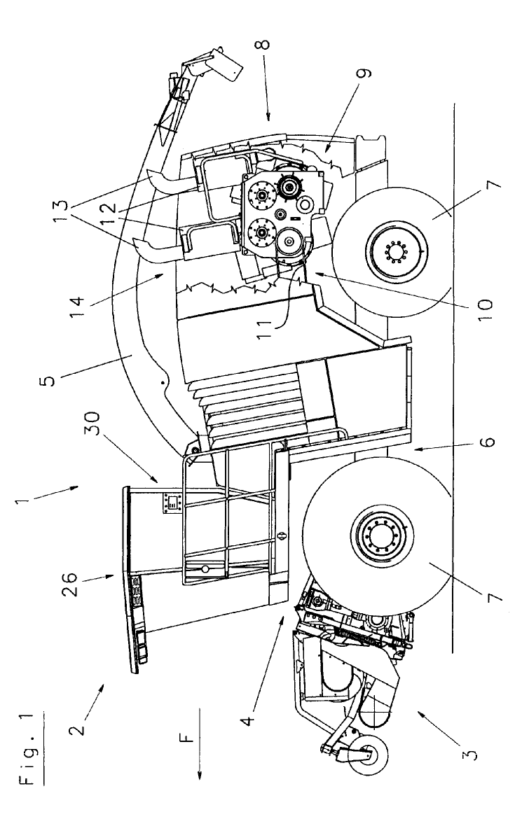

The self-propelled agricultural working machine 1 in the embodiment illustrated in FIG. 1 is a field chopper 2 basically known in the art. In the illustrated embodiment, the field chopper 2 designed in accordance with the features of the present invention is provided with a pick-up and feed device 3 configured as an attachment for a crop that is preferably lying flat on the ground in swaths. The picked-up crop is then supplied by a working device 4, not illustrated in detail, to the working machine 1 for chopping and is subsequently transferred by means of the unloading spout 5 preferably to a transport vehicle.

The working machine 1 mounted on a chassis 6 that is self-propelled and supported and movable on the ground by wheels 7 is driven as a whole by the drive unit 8. The hydraulic propelling drive as well as the drives for the pick-up and feed device 3 and for the working device 4 originate at the drive unit 8. By partial removal of the covers, FIG. 1 illustrates partially only schematically the drive unit 8 as a special feature of the invention.

In the illustrated embodiment onto the left machine side, viewed in the traveling direction F, especially the unit 9 transmitting rotational movement and the main power train 10 extending therefrom are illustrated; the main power train 10 drives by means of a drive belt 11 as a force-transmitting means mainly the working device 4. Moreover, two mufflers 12 with their tail pipes 13 are illustrated as external features of the two drive motors 14 of the drive unit 8.

Because of the particularly advantageous arrangement of this compact and heavy drive unit 8 such that it is still behind the rear axle of the field chopper 2 in accordance with the invention, the drive unit 8 acts as a weight-compensating mass relative to the heavy harvesting attachments at the front end. FIG. 1 also shows the relatively low configuration resulting from the two small drive motors 14 and the low mounting position of the drive unit 8. This contributes advantageously to a low center of gravity and thus also to stability when stationary as well as when traveling.

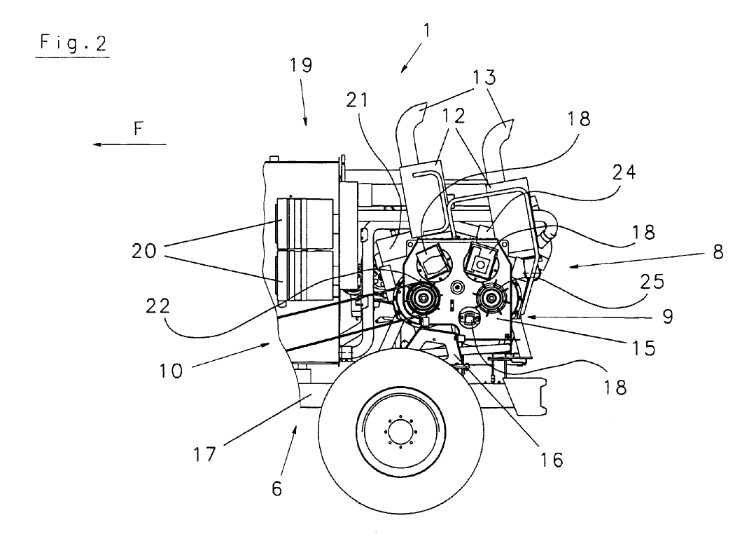

FIG. 2 shows in detail the rear area of the field chopper 2 without covers in the same view as in FIG. 1. In this embodiment, the unit 9 of the drive unit 8 that transmits rotational movement is illustrated as a spur gear 15 and is connected by means of the support 16 to the left lateral frame support 17 of the chassis 6. Instead of a spur gear it is also possible to use a planetary gear for the common gear unit 9. The connection between the drive unit 8 and the chassis 6 that is illustrated as a rigid connection in the drawing is conceivable in other embodiments so as to be elastic and vibration-damping, for example, by providing rubber/metal connecting elements. In addition to the main power train 10, FIG. 2 also shows the hydraulic pumps 18 of the additional drives of the field chopper that are directly connected (flanged) to the spur gear 15; likewise, the cooling unit 19 and the air filter 20 are illustrated.

The main power train 10 is driven by a direct drive action through the spur gear 15 from the main motor 21 of the two drive motors 14 and can be connected and disconnected by a clutch 22. The main motor 21 is however also constantly in engagement with the spur gear 15 and thus also directly with the hydraulic pumps 18 flanged to the spur gear 15.

Moreover, the main motor 21 also drives all auxiliary devices that are required for its own operation and the operation of the working machine 1; the auxiliary devices will be explained in more detail in the following. In accordance with the invention, the operation of the multi-motor working machine 1 according to the invention is possible with the main motor 21 alone.

The at least one additional drive motor 23, in the illustrated embodiment referred to as auxiliary motor 24, because there is only one additional motor, can be connected by means of clutch 25 illustrated also in FIG. 2. After completion of coupling, the auxiliary motor 24 is also in engagement with the spur gear 15 and with the drive unit 8 and is thus rigidly connected to the main motor 21 so that the total output of both motors 21, 24 is available for all drive units 10, 18 taken off at the spur gear 15. The two drive motors 21, 24 in the illustrated embodiment are identical so that it is thus possible to drive the field chopper 2 according to the invention either only by means of the main motor 21 with half its power output or with the additionally connected auxiliary drive 24 at full power output of the drive unit 8.

The cooling unit 19 of the working machine 1 comprises centrally combined all cooling devices for water, oil, charge air, cooling medium of the drive motors 14, of the hydraulic systems as well as of the air-conditioning device of the driver compartment 26.

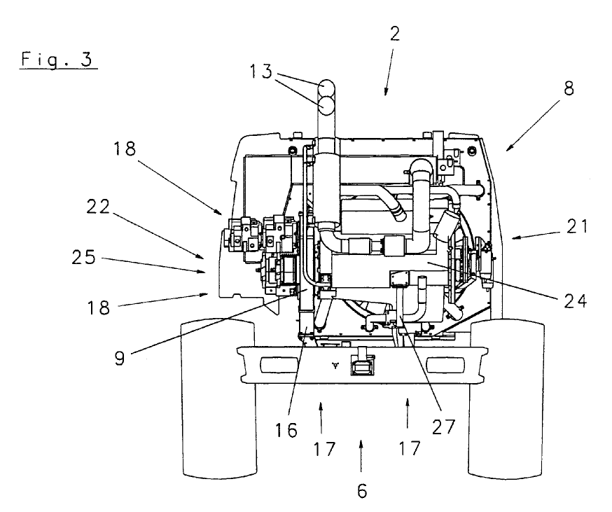

In the view of the field chopper 2 from the rear, as illustrated partially in FIG. 3 and without machine covers or panels, it is easily apparent how compact the drive unit 8 of the working machine according to the invention is and how it can be integrated in an advantageous position regarding the center of gravity in the working machine 1. In addition to the already mentioned support 16, the auxiliary frame 27 can be seen. The auxiliary frame 27 connects, on the one hand, the ends of the motors 21, 24 rigidly to one another and forms, on the other hand, the second connecting element of the drive unit 8 to the chassis 6 of the field chopper 2 in addition to the support 16.

Because of the direct flange connection of the drive motors 14 to one side of the unit 9 transmitting the rotational movement and because of the direct connection of the clutches 22, 25 and the hydraulic pumps 18 at the opposed side, according to the invention a preassembled drive unit 8 for a working machine 1 is made available that, because of its compact design, can be mounted advantageously transversely. Accordingly, it practically generates a connection between the lateral frame supports 17. The easy accessibility of the modules and the already favorable position of the center of gravity of the drive unit can be achieved only by this advantageous configuration.

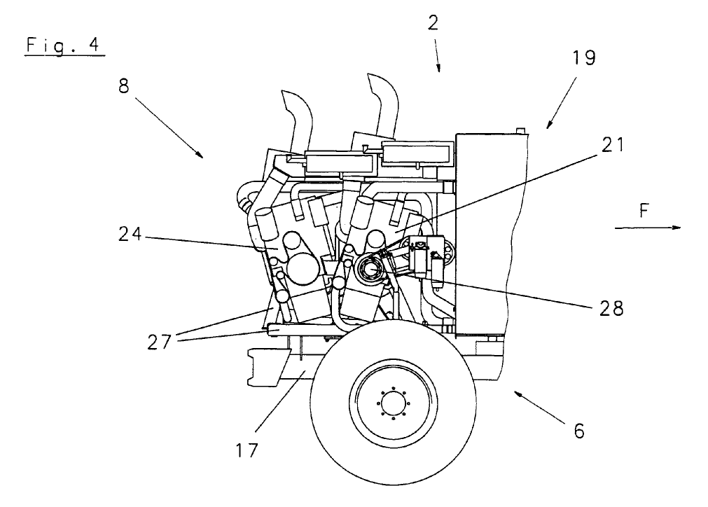

FIG. 4 shows the rear area of the field chopper 2 in accordance with FIG. 2 from the opposite right machine side. In this view onto the ends of the motors 21, 24 the auxiliary frame 27 can be seen as a connecting and supporting element of the drive unit 8. Moreover, it can be seen that the auxiliary drive 28 for the auxiliary devices cooling fan and generator, not illustrated here, is taken off the main motor 21 that is positioned in front in the travel direction F. In another configuration it is also conceivable that all devices are driven alternatingly as needed by each motor so that there is no main motor. The described configuration is however in particular advantageous for cost reasons because further devices, drive elements and complex controls are not needed.

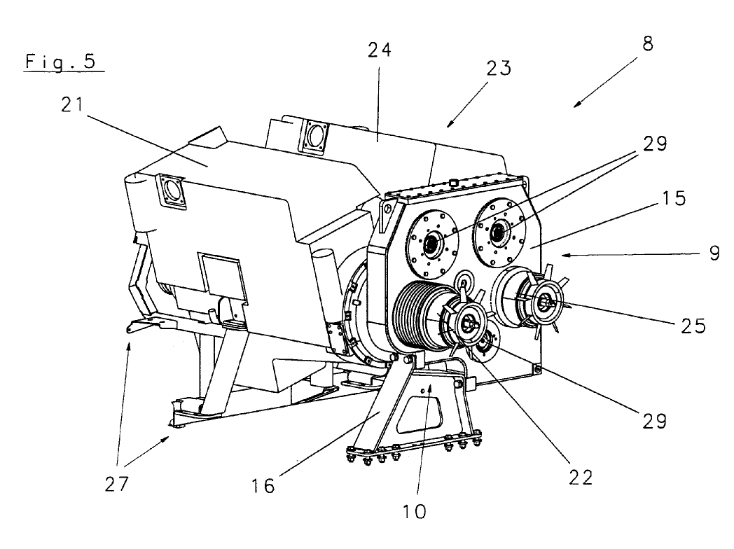

FIG. 5 shows in a perspective partially schematic illustration the drive unit 8 of the field chopper 2 according to the invention with the components main motor 21, auxiliary motor 24, spur gear 15, support 16, auxiliary frame 27 and clutches 22, 25. In this illustration, the hydraulic pumps 18 are not mounted on the output members 29 of the spur gear 15. FIG. 5 illustrates in particular how by means of the features of the invention, inter alia, a mountable compact drive unit 8 for a self-propelled agricultural working machine 1 is provided that in this embodiment is illustrated in the form of a field chopper 2. It can be seen particularly well how by means of the advantageous arrangement of the main motor 21, the main power train 10 that can be connected by the clutch 22 is driven by the main motor 21 in direct force flow, without diversion through the unit 9 transmitting the rotational movement. At the same time, there is the possibility of connecting to the main power train 10 the output of at least one additional motor 23. Coupling of the two motors 21 and 24 in the illustrated embodiment is realized by the clutch 25. The clutch 25 provides force transmission between the auxiliary motor 24 and the spur gear 15 and thus also between the motors 21 and 24. In order to keep the loads at the moment of coupling as low as possible for the clutch 25 as well as for the components of the spur gear 15, conditions in regard to synchronization of the motors 21, 24 are required for the coupling process.

When the operator of the field chopper 2 recognizes during operation deriving its drive power only from the main motor 21 that the drive power is insufficient or when it is determined already before beginning the working operation that both motors 21, 24 are needed for the work, it is necessary that first the main motor 21 and then the auxiliary motor 24 is started, respectively.

In the field chopper 2 of the present invention, the auxiliary motor 24 is started as is conventional by a non-illustrated electric starter. According to a further embodiment, it is also conceivable, for example, that the main motor 21 is used to entrain, preferably at low engine speed, upon actuation of the clutch 25 the auxiliary motor 24 or that a mass that can be rotated by the main motor 21 stores kinetic energy and that the kinetic energy, independent of the momentary engine speed of the main motor 21, can be used for starting the auxiliary motor 24. Now the operator provides the starting signal for the multi-motor drive action to the control and regulating device 30 of the working machine 1 and the device 30, in turn, controls the motors 21, 24 such that with regard to the engine speed they operate as synchronously as possible. Only when synchronization is achieved within a predetermined tolerance range, the clutch 25 is activated and the coupling action is carried out. Preferably, the desired synchronization speed is within the upper idle speed because the upper idle speed is already relatively identical and in this engine speed range, because of the minimal torque of the motors 21, 24, the torque differences are also minimal. According to another embodiment, other synchronization possibilities and other synchronization engine speeds or entirely different technical solutions, for example, including freewheeling, are conceivable. The minimal load on the components, the operational safety, and the costs however underscore the advantages of the solution of the illustrated embodiment.

The control and regulating device 30 of the working machine according to the invention has also monitoring and safety functions. It is designed such that smallest disruptions detected by sensors of the drive unit 8 that can present a safety risk or can lead to damage causes an immediately a controlled shut-down of the auxiliary motor 24 and/or switching of at least one of the clutches 22, 25.

While specific embodiments of the invention have been shown and described in detail to illustrate the inventive principles, it will be understood that the invention may be embodied otherwise without departing from such principles.

What is claimed is:

1. A self-propelled harvesting machine comprising:
a chassis supported by drive wheels on the ground;
a first drive for propelling the harvesting machine;
at least one second drive for driving at least one working or harvesting device;
a drive unit providing a variable total drive power for the first and second drives;
wherein the drive unit comprises at least two drive motors;
at least one common gear unit associated with the at least two drive motors for transmitting a rotational movement;
a control and regulating device controlling a course of action for connecting a second one of the at least two drive motors to the common gear unit.

2. The self-propelled harvesting machine according to claim 1, wherein the drive unit and the common gear unit are combined to a compact preassembled module.

3. The self-propelled harvesting machine according to claim 2, comprising an auxiliary frame rigidly connecting the at least two drive motors at an end of the at least two motors facing away from the common gear unit.

4. The self-propelled harvesting machine according to claim 3, wherein the drive unit is a connecting element that connects lateral frame supports of the chassis.

5. The self-propelled harvesting machine according to claim 4, wherein the auxiliary frame is connected to a first one of the lateral frame supports and a support of the common gear unit is connected to a second one of the lateral support so as to be detachable and vibration-damping.

6. The self-propelled harvesting machine according to claim 1, wherein a first one of the at least two drive motors is a main motor.

7. The self-propelled harvesting machine according to claim 1, wherein each one of the at least two drive motors individually comprises supply and discharge devices, wherein the drive unit comprises a common fuel tank and a common air filter for the at least two drive motors.

8. The self-propelled harvesting machine according to claim 1, wherein the drive unit comprises a common cooling system for the at least two drive motors.

9. The self-propelled harvesting machine according to claim 8, wherein the common cooling system of the at least two drive motors is designed such that, when a first one of the at least two drive motors is a main motor and when the main motor is running alone, waste heat of the main motor is used to preheat at least one other drive motor of the at least two drive motors.

10. The self-propelled harvesting machine according to claim 1, wherein the common gear unit is a spur gear or a planetary gear.

11. The self-propelled harvesting machine according to claim 1 wherein the at least two drive motors of the drive unit and the common gear unit are connected to form a separable unit.

12. The self-propelled harvesting machine according to claim 11, wherein one of the at least two drive motors permanently engages the common gear unit.

13. The self-propelled harvesting machine according to claim 1, wherein the at least one second drive for driving the at least one working or harvesting device is driven be one of the at least two drive motors.

14. The self-propelled harvesting machine according to claim 1, wherein a drive power required for operating a cooling device and for a generator operation is provided by only one of the at least two drive motors.

15. The self-propelled harvesting machine according to claim 1, wherein one of the at least two drive motors is a main motor and wherein a main power train of the self-propelled harvesting machine is directly driven by the main motor.

16. The self-propelled harvesting machine according to claim 15, wherein the main power train is configured to be switched for providing a driving action.

17. The self-propelled harvesting machine according to claim 15, wherein the main power train is adapted to be driven commonly by the main motor and at least one additional motor of the at least two drive motors.

18. The self-propelled harvesting machine according to claim 1, wherein further drives of the harvesting machine are connected to power take-offs of the common gear unit.

19. The self-propelled harvesting machine according to claim 1, wherein all drives that are connected to power take-offs of the common gear unit are adapted to be commonly driven by all of the at least two drive motors.

20. The self-propelled harvesting machine according to claim 1, wherein the control and regulating device is adapted to adjust a state of equilibrium regarding an initial torque and motor speed of the at least two drive motors for coupling the at least two drive motors.

21. The self-propelled harvesting machine according to claim 1, wherein the control and regulating device, after receiving a triggering signal, automatically adjust conditions required for coupling the at least two drive motors and carries out coupling of the at least two drive motors.

22. The self-propelled harvesting machine according to claim 1, wherein the control and regulating device monitors an operational state of the at least two drive motors and an interaction of the at least two drive motors such that, when disruptions occur, measures are initiated that prevent accidents and damage.

23. The self-propelled harvesting machine according to claim 22, wherein the control and regulating device is configured such that immediately a separation of the force flow of one of the at least two drive motors acting as an auxiliary drive motor from the common gear unit is effected by a clutch.

24. The self-propelled harvesting machine according to claim 1, wherein at least one of a type of application and operating conditions of an application determine how many of the at least two drive motors are employed.

25. The self-propelled harvesting machine according to claim 24, wherein for traveling on a road only one of the at least two drive motors propels the self-propelled harvesting machine.
